(19) United States
(12) Patent Application Publication
(10) Pub. No.: US 2013/0224506 A1
(43) Pub. Date: Aug. 29, 2013

(54) BLENDS OF IONOMERS AND SUB-PARTIALLY HYDROLYZED POLY(VINYL ALCOHOL)S

(71) Applicant: E I DU PONT DE NEMOURS AND COMPANY, (US)

(72) Inventors: Elliott Echt, Wilmington, DE (US); Richard Allen Hayes, Beaumont, TX (US)

(73) Assignee: E I DU PONT DE NEMOURS AND COMPANY, Wilmington, DE (US)

(21) Appl. No.: 13/780,463

(22) Filed: Feb. 28, 2013

Related U.S. Application Data
(60) Provisional application No. 61/604,541, filed on Feb. 29, 2012.
(60) Provisional application No. 61/604,550, filed on Feb. 29, 2012.

(51) Int. Cl. C09D 129/04; C09D 133/06; B65D 25/14

(52) U.S. Cl. CPC C09D 129/04; B65D 25/14; C09D 133/06
USPC 428/514; 524/503; 427/385.5; 427/391; 427/389.9; 427/388.1; 156/60

(57) ABSTRACT

Disclosed is a blend composition comprising a combination of (a) about 99 to about 1 weight %, based on the combination of (a) and (b), of a sub-partially hydrolyzed poly(vinyl alcohol) characterized by a hydrolysis level of from about 72 to about 84 mole %; and (b) about 1 to about 99 weight % of an ionomer comprising a parent acid copolymer that comprises ethylene and about 18 to about 30 weight % of acrylic acid or methacrylic acid, the acid copolymer having a melt flow rate from about 200 to about 1000 g/10 min., wherein about 50% to about 70% of the carboxylic acid groups of the copolymer are neutralized to carboxylic acid salts comprising potassium and/or sodium cations. Also disclosed are aqueous dispersions and methods to prepare the aqueous dispersions. Articles and multilayer structures comprising the blend composition on a substrate and methods for their preparation are also disclosed.

This application claims priority to U.S. Patent Application Ser. No. 61/604,541, filed Feb. 29, 2012 and U.S. Patent Application Ser. No. 61/604,550, filed Feb. 29, 2012.

### FIELD OF THE INVENTION

The present invention is directed to compositions, aqueous dispersions and articles comprising blends of ionomers and sub-partially hydrolyzed poly(vinyl alcohol)s, and methods to prepare them.

### BACKGROUND OF THE INVENTION

Ionomers of ethylene copolymers with alpha,beta-ethylenically unsaturated carboxylic acids are known in the art, wherein at least a portion of the carboxylic acid groups of the copolymer are neutralized to form carboxylate salts comprising alkali metal, alkaline earth metal or transition metal cations. See for example U.S. Pat. Nos. 3,264,272; 3,338,739; 3,355,319; 5,155,157; 5,244,969; 5,304,608; 5,542,677; 5,591,803; 5,688,869; 6,100,336; 6,245,858; 6,518,365; and U.S. Patent Application Publication 2009/0297747.

Aqueous dispersions of ionomers are also known in the art. See for example U.S. Pat. Nos. 3,896,065; 3,904,569; 4,136,069; 4,508,804; 5,409,765; and Japanese Patent Applications JP01009338 and JP05075769. They have been produced by dissolving the acid copolymer precursors in a solvent, neutralization of the acid functionalities with generally ammonia, amines or alkali metal ions, and dilution of the solution into water followed by partial or complete removal of the solvent. See for example U.S. Pat. Nos. 2,313,144; 3,296,172; 3,389,109; 3,562,196; 5,430,111; 5,591,806; British Patent GB1243303; Japanese Patent Applications JP50084687 and JP2009091426.

Aqueous ionomer dispersions have also been produced by heating acid copolymer precursors or ionomers in hot aqueous ammonia and other neutralizing agents. See for example U.S. Pat. Nos. 3,644,258; 3,674,896; 3,823,108; 3,872,039; 3,899,389; 3,970,626; 3,983,268; 4,400,440; 4,540,736; 5,160,484; 5,206,279; 5,330,788; 5,387,635; 5,550,177; 6,852,792; U.S. Patent Application Publication 2007/0117916; Japanese Patent Application JP06000872; and PCT Patent Application Publication WO2000/044801.

Aqueous ionomer dispersions have also been produced by dispersing the acid copolymer precursor in aqueous solutions of neutralizing agents at temperatures under high shear process conditions above the boiling point of water, necessitating the use of pressure vessels such as autoclaves and extruders. See for example U.S. Pat. Nos. 4,775,713; 4,970,258; 4,978,707; 5,082,697; 5,374,687; 5,445,893; 5,993,604; 6,482,886; 7,279,513; 7,528,080; 7,588,662; U.S. Patent Application Publications 2005/0100754; 2005/0271888; 2006/0124554; 2007/0137808; 2007/0137809; 2007/0137810; 2007/0137811; 2007/0137813; 2007/0141323; 2007/0144697; 2007/0243331; 2007/0284069; 2007/0292705; 2007/0295464; 2007/0295465; 2008/0000598; 2008/0000602; 2008/0041543; 2008/0073045; 2008/0073046; 2008/0118728; 2008/0135195; 2008/0176968; 2008/0182040; 2008/0216977; 2008/0230195; 2008/0292833; 2008/0295985; 2009/0194450; 2009/0253321; European Patent Application EP1163276; PCT Patent Application WO 2011/058119; WO 2011/058121; WO 2011/068525; and Japanese Patent Applications JP2958102; JP10006640; and JP50135141.

Aqueous ionomer dispersions have also been produced by dispersing the ionomer in aqueous solutions under high shear process conditions at temperatures above the boiling point of water, necessitating the use of pressure vessels such as autoclaves and extruders. See for example U.S. Pat. Nos. 4,173,669; 4,329,305; 4,410,655; 440,908; 6,458,897; Japanese Applications JP11158332; JP2000328046; JP2005075878; and PCT Patent Application Publication WO1999/10276.

Aqueous ionomer dispersions have also been produced by dispersing highly neutralized, low melt index (MI) ionomers in hot water. See for example U.S. Pat. Nos. 3,321,819; 3,472,825; and 4,181,566.

Blends of aqueous ionomer dispersions with poly(vinyl alcohol) solutions are known in the art. See for example U.S. Pat. Nos. 3,674,896; 3,896,065; 4,547,456; 4,575,532; 4,600,746; 5,192,620; 5,358,790; and 6,821,373; European Patent Application EP 868363; Japanese Applications JPH09124975; JP2003049035; and JP60072973. The blends described suffer the shortcoming of a complicated ionomer dispersion process, as discussed above.

### SUMMARY OF THE INVENTION

The invention relates to a blend composition comprising or consisting essentially of

(a) about 99 to about 1 weight %, based on the combination of (a) and (b), of a sub-partially hydrolyzed poly(vinyl alcohol) composition comprising or consisting essentially of a poly(vinyl alcohol) with a hydrolysis level from about 72 to about 84 mole %; and

(b) about 1 to about 99 weight % of an ionomer composition comprising or consisting essentially of a parent acid copolymer that comprises copolymerized units of ethylene and about 18 to about 30 weight % of copolymerized units of acrylic acid or methacrylic acid, based on the total weight of the parent acid copolymer, the acid copolymer having a melt flow rate (MFR) from about 200 to about 1000 g/10 min., measured according to ASTM D1238 at 190° C. with a 2160 g load, wherein about 50% to about 70% of the carboxylic acid groups of the copolymer, based on the total carboxylic acid content of the parent acid copolymer as calculated for the non-neutralized parent acid copolymer, are neutralized to carboxylic acid salts comprising potassium cations, sodium cations or combinations thereof.

The invention also relates to an aqueous ionomer-poly(vinyl alcohol) dispersion comprising or consisting essentially of water and about 1 to about 50 weight % of the combination of (a) and (b) described above.

The invention also provides an article comprising or consisting essentially of the blend composition above.

The invention also provides a method for making an aqueous ionomer-poly(vinyl alcohol) dispersion comprising a mixture of an ionomer composition and a poly(vinyl alcohol) composition, the method comprising or consisting essentially of

(1) providing an aqueous poly(vinyl alcohol) solution comprising or consisting essentially of water and the poly(vinyl alcohol) composition described in (a) above;

(2) providing an ionomer composition comprising or consisting essentially of the ionomer composition described in (b) above; and

(3) mixing the ionomer composition with the aqueous poly(vinyl alcohol) composition solution optionally with heating; and

(4) optionally cooling the heated aqueous blend dispersion to a temperature of about 20 to about 30° C., wherein the combination remains dispersed in the liquid phase;

wherein the aqueous ionomer-poly(vinyl alcohol) dispersion is as described above.

The invention also provides a method for making an aqueous ionomer-poly(vinyl alcohol) dispersion comprising a mixture of an ionomer composition and a poly(vinyl alcohol) composition, the method comprising or consisting essentially of

(1) providing an aqueous poly(vinyl alcohol) solution comprising or consisting essentially of water and the poly(vinyl alcohol) composition described in (a) above;

(2) providing an ionomer composition comprising or consisting essentially of the ionomer composition described in (b) above; and

(3) mixing the ionomer composition with the aqueous poly(vinyl alcohol) composition solution optionally with heating to provide a heated aqueous blend dispersion; and

(4) optionally cooling the heated aqueous blend dispersion to a temperature of about 20 to about 30° C., wherein the combination remains dispersed in the liquid phase;

wherein the aqueous ionomer-poly(vinyl alcohol) dispersion is as described above.

The invention also provides a method to form a coating comprising a blend of ionomer and poly(vinyl alcohol) on a substrate, the method comprising or consisting essentially of

(1) providing a blend composition as described above;

(2) providing a substrate; and

(3) coating the blend composition onto the substrate.

In one embodiment, the blend composition is provided in the form of an aqueous dispersion comprising or consisting essentially of water and about 1 to about 50 weight % of the combination of (a) and (b); the blend composition is coated onto the substrate as the aqueous dispersion and the method further comprises (4) drying the coated substrate at a temperature of about 20 to about 150° C.

In another embodiment, the blend composition is provided in the form of a preformed film comprising or consisting essentially of the combination of (a) and (b); (3) comprises (3a) producing a prelaminate structure comprising the ionomer-poly(vinyl alcohol) film layer adjacent to the substrate; and (3b) laminating the ionomer-poly(vinyl alcohol) film layer to the substrate at a temperature from about 50 to about 150° C., optionally with applied pressure; and the method further comprises (4) cooling the coated substrate to a temperature of about 20 to about 30° C.

The invention also provides an article or multilayer structure comprising the coated substrate as described above.

### DETAILED DESCRIPTION OF THE INVENTION

Unless otherwise defined, all technical and scientific terms used herein have the same meaning as commonly understood by one of ordinary skill in the art to which this invention belongs. In case of conflict, the specification, including definitions, will control.

Although methods and materials similar or equivalent to those described herein can be used in the practice or testing of the invention, suitable methods and materials are described herein.

Unless stated otherwise, all percentages, parts, ratios, etc., are by weight.

When an amount, concentration, or other value or parameter is given as either a range, preferred range or a list of lower preferable values and upper preferable values, this is to be understood as specifically disclosing all ranges formed from any pair of any lower range limit or preferred value and any upper range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

The transitional phrase “consisting essentially of” limits the scope of a claim to the specified materials or steps and those that do not materially affect the basic and novel characteristic(s) of the claimed invention. Where applicants have defined an invention or a portion thereof with an open-ended term such as “comprising,” unless otherwise stated the description should be interpreted to also describe such an invention using the term “consisting essentially of”.

Use of “a” or “an” are employed to describe elements and components of the invention. This is merely for convenience and to give a general sense of the invention. This description should be read to include one or at least one and the singular also includes the plural unless it is obvious that it is meant otherwise.

In describing certain polymers it should be understood that sometimes applicants are referring to the polymers by the monomers used to produce them or the amounts of the monomers used to produce the polymers. While such a description may not include the specific nomenclature used to describe the final polymer or may not contain product-by-process terminology, any such reference to monomers and amounts should be interpreted to mean that the polymer comprises copolymerized units of those monomers or that amount of the monomers, and the corresponding polymers and compositions thereof.

The term “copolymer” is used to refer to polymers formed by copolymerization of two or more monomers. Such copolymers include dipolymers consisting essentially of two copolymerized comonomers.

As used herein, “disperse,” “dispersing” and related terms refer to a process in which solid articles such as pellets of polymer are mixed with water and over a brief period of time disappear into the liquid phase. The terms “aqueous dispersion” and “dispersion” describe a free-flowing liquid with no solids visible to the human eye. No characterization is made regarding the interaction of the polymer molecules with the water molecules in such aqueous dispersions. “Self-dispersible” means that the material disperses readily in hot (80 to 100° C.) water without need for additional dispersants or reagents.

Viscosity is a measure of the resistance of a fluid to flow or movement by shear stress. In everyday terms for fluids only, viscosity may be thought of as “thickness” or “internal friction”. For example, water is “thin”, having a lower viscosity, while honey is “thick”, having a higher viscosity. The less viscous a fluid is, the greater its ease of movement (fluidity). Viscosity is the slope of a plot of the shear stress vs. the velocity gradient. As used herein, viscosity refers to dynamic or absolute viscosity.

As used herein, the terms “poly(vinyl alcohol)” and “PVOH” refer generally to poly(vinyl alcohol) homopolymers or copolymers unless specified with more particularity.

Methods to produce aqueous dispersions comprising certain ionomer-sub-partially hydrolyzed poly(vinyl alcohol) combinations are disclosed herein. In contrast, previous methods required significantly more rigorous conditions to form dispersions. The dispersion methods provide process simplifications that require less energy and are inherently safer than disclosed in the prior art dispersion methods, such as high pressure, high shear, autoclave processes or extrusion processes.

Combinations of ionomers and sub-partially hydrolyzed poly(vinyl alcohol) with certain compositional characteristics readily form aqueous dispersions when mixed with hot water under low shear conditions. Such combinations may form surprisingly high viscosity aqueous dispersions.

Sub-Partially Hydrolyzed Poly(Vinyl Alcohol) Composition

Poly(vinyl alcohol) compositions can be obtained by known and conventional methods. Poly(vinyl alcohol) compositions are typically obtained through polymerization of vinyl acetate monomer, followed by conversion of the as-made poly(vinyl acetate) composition to the poly(vinyl alcohol) composition through alcoholysis or hydrolysis processes. Strictly, alcoholysis is carried out with a basic catalyst in alcohol as reaction medium and leads to the corresponding alkyl acetate and the poly(vinyl alcohol) unit. Hydrolysis, in water, generally uses larger amounts of metallic caustic base, leading to the poly(vinyl alcohol) unit and the corresponding metal acetate rather than alkyl acetate. Formation of metal salts, i.e. acetates, has led to use of the term “saponification” for the process, akin to formation of metal salts of fatty acids with caustic, in making soaps. When aqueous alcohol is used as the reaction medium both hydrolysis and alcoholysis may occur. However, U.S. Pat. No. 2,940,948 discloses that under specific circumstances, even with aqueous alcohol, alcoholysis rather than hydrolysis occurs. While the distinction strictly depends on reaction products, the terms have tended to be used non-rigorously. The poly(vinyl alcohol) products are typically referred to as “hydrolyzed” or “saponified”.

It is common to use the terms “partially hydrolyzed”, or “partially saponified” when not all the acetate groups are completely converted to alcohol groups. When poly(vinyl acetate) homopolymer is only partially hydrolyzed, the resulting poly(vinyl alcohol) is actually a vinyl alcohol/vinyl acetate copolymer. However, as noted, such polymers are generally referred to as partially hydrolyzed poly(vinyl alcohol) homopolymers. Commercially, the term partially hydrolyzed is typically used for PVOH with 86 to 89% hydrolysis levels. Below 86% hydrolysis there is no standard term, but “sub-partially hydrolyzed” has been used. For simplicity of description, the term “sub-partially hydrolyzed” or the abbreviation “SPHPVOH” is used herein for PVOH with hydrolysis levels from about 72 to about 84 mole %, such as about 72 to about 79 mole %.

The viscosity of poly(vinyl alcohol) as a 4 weight % aqueous dispersion at 20° C. serves as an industrial standard relating to the degree of polymerization and average molecular weight of the poly(vinyl alcohol) composition.

The 4 weight % aqueous viscosity at 20° C. of the SPHPVOH composition useful for preparing aqueous dispersions with ionomers may be from about 1 to about 75 cp, such as from a lower limit of about 1 to an upper limit of about 7, 10, 15, 20, 25 or 35 cp, or from a lower limit of about 7, 10, 15, 20 or 25 to an upper limit of about 35, 45, 60 or 75 cp.

Aqueous solutions comprising about 5 to about 20 weight % of such SPHPVOH compositions may have viscosity at 20° C. of about 20 to about 50,000 cp or higher.

The combination of the 4 weight % aqueous viscosity and the hydrolysis level of the poly(vinyl alcohol) composition provides desirable attributes when blended with the ionomer composition, provided they have the hydrolysis and viscosity attributes described above. For example, aqueous dispersions of the SPHPVOH and ionomer may be formed under the mild conditions described herein. Such aqueous dispersions may exhibit higher than expected viscosity.

Optionally, sub-partially hydrolyzed poly(vinyl alcohol) copolymers are also useful for forming aqueous dispersions. The term “copolymer” in this regard is used herein for materials which result from hydrolysis of a vinyl acetate copolymer also containing units derived from a monomer other than vinyl acetate, such an alkyl acrylate, including for example methyl acrylate or methyl methacrylate.

The sub-partially hydrolyzed poly(vinyl alcohol) composition may also contain other additives known in the art. The additives may include, but are not limited to, processing aids, flow enhancing additives, lubricants, pigments, dyes, flame retardants, impact modifiers, nucleating agents, anti-blocking agents such as silica, thermal stabilizers, UV absorbers, UV stabilizers, surfactants, chelating agents, and/or coupling agents.

Ionomer Composition

The ionomer used herein is derived from certain parent acid copolymers comprising copolymerized units of ethylene and about 18 to about 30 weight % of copolymerized units of an alpha, beta-ethylenically unsaturated carboxylic acid such as acrylic acid or methacrylic acid. Preferably, the parent acid copolymer used herein comprises about 19 to about 25 weight %, or more preferably about 19 to about 23 weight %, of the alpha, beta-ethylenically unsaturated carboxylic acid, based on the total weight of the copolymer.

Preferably, the alpha, beta-ethylenically unsaturated carboxylic acid is methacrylic acid. Of note are acid copolymers consisting essentially of copolymerized units of ethylene and copolymerized units of the alpha, beta-ethylenically unsaturated carboxylic acid and 0 weight % of additional comonomers; that is, dipolymers of ethylene and the alpha, beta-ethylenically unsaturated carboxylic acid. Preferred acid copolymers are ethylene methacrylic acid dipolymers.

The parent acid copolymers used herein may be polymerized as disclosed in U.S. Pat. Nos. 3,404,134; 5,028,674; 6,500,888; and 6,518,365.

The parent acid copolymers used herein preferably have a melt flow rate (MFR) of about 200 to about 1000 grams/10 min as measured by ASTM D1238 at 190° C. using a 2160 g load. A similar ISO test is ISO 1133. Alternatively, the parent acid copolymers have MFR from a lower limit of 200, 250 or 300 to an upper limit of 400, 500, 600 or 1000. The preferred melt flow rate of the parent acid copolymer provides ionomers with optimum physical properties in the final shaped article while still allowing for rapid self-dispersion in hot water. Ionomers derived from parent acid copolymers with melt flow rates below about 200 grams/10 minutes have minimal hot water self-dispersibility, while ionomers derived from parent acid copolymer melt flow rates of greater than about 1000 grams/10 minutes may reduce the physical properties in the intended enduse.

In some embodiments, blends of two or more ethylene acid copolymers may be used, provided that the aggregate components and properties of the blend fall within the limits described above for the ethylene acid copolymers. For example, two ethylene methacrylic acid dipolymers may be used such that the total weight % of methacrylic acid is about 18 to about 30 weight % of the total polymeric material and the melt flow rate of the blend is about 200 to about 1000 grams/10 min.

The ionomers disclosed herein are produced from the parent acid copolymers, wherein from about 50 to about 70%, or preferably from about 55 to about 60%, such as about 59 to about 60%, of the total carboxylic acid groups of the parent acid copolymers, as calculated for the non-neutralized parent acid copolymers, are neutralized to form carboxylic acid salts with potassium ions, sodium ions or combinations thereof. The parent acid copolymers may be neutralized using methods disclosed in, for example, U.S. Pat. No. 3,404,134. Ionomers wherein the cations of the carboxylate salts consist essentially of sodium cations are notable.

Importantly, the ionomer compositions combine the properties of being self-dispersible in hot water along with being thermoplastic, allowing for melt fabrication into many articles of commerce. Preferably, the ionomers used herein have a melt flow rate (MFR) of at least 1 gram/10 min, such as about 1 to about 20 grams/10 min as measured by ASTM D1238 at 190° C. using a 2160 g load. More preferably, the ionomer composition has a MFR of about 1 to about 10 grams/10 min, and most preferably has a MFR of about 1 to about 5 grams/10 min. The combination of the above described parent acid copolymer melt flow rates and the neutralization levels provides ionomers which combine the properties of being easily self-dispersible in hot water and easily melt fabricated into articles of commerce.

In some embodiments, blends of two or more ionomers may be used, provided that the aggregate components and properties of the blend fall within the limits described above for the ionomers.

Aqueous dispersions comprising about 5 to about 20 weight % of such ionomers may have viscosity at 23° C. of about 1 to about 30 cp.

The ionomer composition may also contain other additives known in the art. The additives may include, but are not limited to, processing aids, flow enhancing additives, lubricants, pigments, dyes, flame retardants, impact modifiers, nucleating agents, anti-blocking agents such as silica, thermal stabilizers, UV absorbers, UV stabilizers, surfactants, chelating agents, and coupling agents.

Blend Composition

The blend composition comprises or consists essentially of a combination of about 1 to about 99 weight % of a sub-partially hydrolyzed poly(vinyl alcohol) composition and about 99 to about 1 weight % of an ionomer composition, wherein the ionomer and sub-partially hydrolyzed poly(vinyl alcohol) are as described above.

Of note are compositions wherein the ionomer is present in the combination in an amount from a lower limit of about 10, 20, 30, 40 or 50 weight % to an upper limit of about 60, 70, 80, 90, or 95 weight %, the SPHPVOH being present in a complementary amount. Also of note are compositions wherein the ionomer is present in the combination in an amount from a lower limit of about 60, 70, or 75 weight % to an upper limit of about 80, 85, 90 or 95 weight %, the SPHPVOH being present in a complementary amount.

Preferably, the ionomer and the SPHPVOH may be blended in an aqueous dispersion as discussed in greater detail below. Use of dispersions to form films and coatings instead of extrusion avoids heating the SPHPVOH above its melting point. Preferably the pH of the aqueous dispersion is above about 8.5. Below pH of about 8.5 the ionomer may not be well dispersed. The aqueous blend dispersion can in turn be processed into a solid by drying (removal of water) to provide an article. For example, the aqueous blend dispersion may be formed into a cast film by forming a thin layer of the aqueous blend, followed by drying.

The blend composition article may take any physical form desired, such as powder, pellets, melt cut pellets, coatings, films, sheets, molded articles and the like.

Dispersion Method

In some instances, when an aqueous dispersion of the ionomer and sub-partially hydrolyzed poly(vinyl alcohol) with a hydrolysis level from about 72 to about 84 mole % is formed, the viscosity of the dispersion may be at least 20% higher than a similar aqueous dispersion of the SPHPVOH without ionomer. The viscosity at 25° C. may be from about 700 centipoise to about 24,000 centipoise or higher. For comparison, the viscosity at 25° C. of water is 0.894 centipoise and chocolate syrup may range from about 10,000 to about 25,000 centipoise, depending on its composition and water content.

A method for making an aqueous ionomer-poly(vinyl alcohol) dispersion comprising a mixture of an ionomer composition and a sub-partially hydrolyzed poly(vinyl alcohol) composition comprises or consists essentially of

(1) providing an aqueous poly(vinyl alcohol) solution comprising or consisting essentially of water and the poly(vinyl alcohol) composition described in (a) above;

(2) providing an ionomer composition comprising or consisting essentially of the ionomer composition described in (b) above; and

(3) mixing the ionomer composition with the aqueous poly(vinyl alcohol) composition solution optionally with heating; and

(4) optionally cooling the heated aqueous blend dispersion to a temperature of about 20 to about 30° C., wherein the combination remains dispersed in the liquid phase;

wherein the aqueous ionomer-poly(vinyl alcohol) dispersion is as described above.

The dispersion method described herein surprisingly allows for the production of aqueous dispersions of combinations of sub-partially hydrolyzed poly(vinyl alcohol) and ionomers under very mild process conditions, such as low shear (e.g. simply stirring a mixture of a hot poly(vinyl alcohol) and an ionomer, either as a solid or as an aqueous dispersion and low temperature (less than the boiling point of water at atmospheric pressure), requiring less energy than prior art dispersion processes. This dispersion method further provides an inherently safer dispersion process through the use of preformed blend compositions by allowing for the avoidance of strong bases, such as aqueous sodium hydroxide (caustic), aqueous potassium hydroxide or ammonia, during the dispersion process.

Strictly speaking, the blend dispersion generally includes a solution of the SPHPVOH composition, and a dispersion of the ionomer composition hereinafter referred to as a dispersion for brevity.

The aqueous sub-partially hydrolyzed poly(vinyl alcohol) solution may be prepared by any method disclosed in the art. Generally, such processes include forming a mixture of the sub-partially hydrolyzed poly(vinyl alcohol) composition in water at a temperature of about 20° C. to about 30° C., followed by heating the mixture at a temperature and for a time until the SPHPVOH composition dissolves to form the aqueous SPHPVOH solution. The aqueous dissolution temperature of the SPHPVOH composition is generally dependent on the hydrolysis level of the specific SPHPVOH composition. For SPHPVOH with hydrolysis levels of about 72 to about 84 mole %, the aqueous dissolution temperature is generally in the temperature range from about 20° C. to about 60° C. In order to prepare the solution faster, it may be useful to heat the mixture of water and SPHPVOH at temperatures higher than the threshold temperature for dissolution. For example, the water-SPHPVOH mixture may be heated to about 90 to about 95° C., regardless of hydrolysis level.

The poly(vinyl alcohol) solution may be produced in any suitable vessel, such as a tank, vat, pail or the like. Stirring is important to provide effective contact of the bulk solid poly(vinyl alcohol) composition with water as dissolution proceeds to avoid clumping of the PVOH. The solution may be produced in about 1 hour at about 90° C. for batch processes.

Alternatively, it is further contemplated that the dissolution process may be conducted in a continuous process. For example a continuous or “jet” cooker can be used, where a suspension of polyvinyl alcohol is mixed with steam in a closed pipe under pressure and exits the pressurized pipe portion fully dissolved, or hot enough to complete the dissolving process in a few minutes, depending on the particle size of the polyvinyl alcohol.

The aqueous SPHPVOH solution preferably comprises from a lower limit of about 0.1 or about 1% to an upper limit of about 10, about 20, about 30 or about 50 weight %, of the SPHPVOH based on the total weight of the blend composition and the water.

In some embodiments, the dispersion method comprises providing a preformed aqueous dispersion of an ionomer composition and mixing it with the preformed aqueous solution of a SPHPVOH. The aqueous ionomer dispersion may be formed by mixing the solid ionomer composition with water heated to a temperature from about 80 to about 100° C. (under low shear conditions) to provide a heated aqueous ionomer composition dispersion; optionally followed by cooling to a temperature of about 20 to about 30° C., wherein the ionomer remains dispersed in the aqueous phase.

The aqueous dispersion of an ionomer composition can be produced by contacting the solid ionomer composition, for example, in the form of melt cut pellet(s), with water at a temperature from about 80 to about 100° C. In some embodiments, the temperature is in the range from about 85 to about 90° C. Surprisingly, the ionomer compositions described herein can be dispersed in water at 80 to 100° C., lower than that expected based on the prior art and requiring significantly less energy. However, one can appreciate that if the ionomer compositions disperse in that temperature range they can also be dispersed at temperatures above 100° C.

The ionomer dispersion may be produced in any suitable vessel, such as a tank, vat, pail or the like. Stirring is useful to provide effective contact of the bulk solid ionomer composition with water as dispersion proceeds. Preferably the dispersion is produced in about 1 hour or less, such as in about 30 minutes or in about 20 minutes or less. Smaller particle size of the solid ionomer may reduce time of dispersion. Due to the surprisingly rapid dispersibility of the ionomer compositions, it is further contemplated that the process may proceed within a pipeline in which the components of the dispersion are charged at one end of the pipeline and form the dispersion as they proceed down the length of the pipeline. For example, the ionomer composition may be mixed with water and passed through a heated zone, with or without added mixing, such as through static mixers. Alternatively, the ionomer composition may be mixed with hot water and passed through a pipeline, with or without added mixing, such as through static mixers.

In one embodiment, the ionomer composition is mixed with water under low shear conditions at room temperature (about 20 to about 25° C.) and the temperature is raised to about 80 to about 100° C. In another embodiment, the ionomer composition is mixed with water under low shear conditions at room temperature and the temperature is raised to about 85 to about 90° C.

In another embodiment, the ionomer composition is mixed with water preheated to a temperature of about 80 to about 100° C. under low shear conditions. In another embodiment, the ionomer composition is mixed with water preheated to a temperature of about 85 to about 90° C. under low shear conditions.

The aqueous ionomer composition dispersion preferably comprises from a lower limit of about 0.1 or about 1% to an upper limit of about 10, about 20, about 30 or about 50 weight %, of the ionomer composition based on the total weight of the blend composition and the water.

Once prepared, the aqueous poly(vinyl alcohol) solution and the aqueous ionomer dispersion may be mixed together by any suitable means, with or without additional heating. In some instances, the aqueous poly(vinyl alcohol) solution and the aqueous ionomer dispersion may be maintained at or near the elevated temperatures necessary for their preparation through the mixing step. The resulting aqueous blend may be used in additional operations at the elevated temperatures necessary for its preparation. Alternatively, the resulting aqueous blend may then be cooled to ambient temperatures (about 20 to about 30° C.) for storage or subsequent use.

The blend dispersion may also be prepared by mixing the aqueous PVOH solution with the aqueous ionomer dispersion, both at about 20 to about 30° C. before and through the mixing step.

The order of mixing the aqueous SPHPVOH solution and the aqueous ionomer dispersion is not critical, provided the SPHPVOH is in the form of an aqueous solution prior to mixing with the ionomer dispersion. For example, the SPHPVOH solution may be prepared in a suitable vessel and the aqueous ionomer dispersion, prepared separately, is subsequently added to the vessel. The mixing can occur in any suitable mixing vessel, such as a tank, vat, pail or the like. Stirring may be useful to provide sufficient rapid mixing of the poly(vinyl alcohol) solution and the ionomer dispersion. The mixing may proceed within a pipeline in which the SPHPVOH solution and the ionomer dispersion components of the blend dispersion are charged at one end of the pipeline and form the blend as they proceed down the length of the pipeline, with or without added mixing, such as through static mixers.

In other embodiments, the ionomer in solid form such as melt cut pellets may be mixed with the aqueous sub-partially hydrolyzed poly(vinyl alcohol) solution with heating to prepare the blend dispersion.

In one such embodiment, the method comprises or consists essentially of

(1) heating a mixture of water and a sub-partially hydrolyzed poly(vinyl alcohol) composition described above to provide an aqueous sub-partially hydrolyzed poly(vinyl alcohol) solution;

(2) the ionomer composition comprising or consisting essentially of the ionomer described above is in solid form;

and the mixing of step (3) comprises

(a) heating the aqueous sub-partially hydrolyzed poly(vinyl alcohol) solution to a temperature from about 80 to about 100° C. (under low shear conditions);

(b) contacting a solid ionomer composition with the heated aqueous poly(vinyl alcohol) solution;

(c) continuing heating at a temperature from about 80 to about 100° C. (under low shear conditions) until the solid ionomer composition has completely dispersed; and

(4) optionally cooling to a temperature of about 20 to about 30° C.;

wherein the aqueous ionomer-sub-partially hydrolyzed poly(vinyl alcohol) dispersion is as described above.

In another such embodiment, the method comprises or consists essentially of
(1) heating a mixture of water and a sub-partially hydrolyzed poly(vinyl alcohol) composition described above to provide an aqueous poly(vinyl alcohol) composition solution;
(2) the ionomer composition comprising or consisting essentially of the ionomer described above is in solid form;

and the mixing of step (3) comprises

(d) contacting the solid ionomer composition with the aqueous sub-partially hydrolyzed poly(vinyl alcohol) solution to provide a mixture;

(e) heating the mixture to a temperature from about 80 to about 100° C. (under low shear conditions) until the solid ionomer composition has completely dispersed; and

(4) optionally cooling to a temperature of about 20 to about 30° C.;

wherein the aqueous ionomer-sub-partially hydrolyzed poly(vinyl alcohol) dispersion is as described above.

The order of mixing the aqueous PVOH solution and the solid ionomer is not critical, provided the PVOH is in the form of an aqueous solution prior to mixing with the ionomer and that the pH remains sufficiently high (such as above 8.5) during mixing so that the ionomer particles can disperse. High concentrations of PVOH may result in undesired interaction with the cations in the ionomer leading to poor dispersion. For example, the PVOH solution at 1% concentration may be prepared in a suitable vessel and the solid ionomer is subsequently added to the vessel.

The mixing can occur in any suitable mixing vessel, such as a tank, vat, pail or the like. Stirring may be useful to provide sufficient rapid mixing of the poly(vinyl alcohol) solution and the solid ionomer. Smaller particle size of the solid ionomer may reduce time of dispersion. The mixing may proceed within a heated pipeline in which the PVOH solution and the solid ionomer components of the blend dispersion are charged at one end of the pipeline and form the blend as they proceed down the length of the pipeline, with or without added mixing, such as through static mixers.

Additional water may be added after the initial mixing, if desired, to provide dispersions with lower concentrations of PVOH and ionomer. For example a concentrated dispersion may be prepared and stored for a period of time and then diluted with water to provide a dispersion with lower concentration at the time of use.

The dispersion may include other additives known in the art. For example, the composition may include a wax additive, such as a microcrystalline wax or a polyethylene wax, which serves as an anti-blocking agent as well as to improve the coefficient of friction when used as a dried coating. Other types of additives include fumed silica, which reduces tack of the blend composition at room temperature, fillers, cross-linking agents, anti-static agents, defoamers, dyes, brighteners, processing aids, flow enhancing additives, lubricants, dyes, pigments, flame retardants, impact modifiers, nucleating agents, anti-blocking agents, thermal stabilizers, UV absorbers, UV stabilizers, chelating agents, coupling agents and the like.

Inorganic fillers include calcium carbonate, titanium dioxide, silica, talc, barium sulfate, carbon black, ceramics, chalk or mixtures thereof. Clay fillers natural clays, synthetic clays, treated clays, untreated clays, organoclays, smectite clays, bentonite clays, hectorite days, wollastonite clays, montmorillonite clays, kaolin, or mixtures thereof. Organic fillers include natural starch, modified starch, chemically modified starch, rice starch, corn starch, wood flour, cellulose, and mixtures thereof.

Starch is a natural product composed of various amounts of amylose and amylopectin. As used herein “starch” refers generally to starch, starch derivatives, modified starch, thermoplastic starch, cationic starch, anionic starch, starch esters, such as starch acetate, starch hydroxyethyl ether, alkyl starches, amine starches, phosphate starches and dialdehyde starches. Important plant source of starch used in the paper industry are potato, barley, wheat corn, waxy maize (corn with no amylose in the starch), and tapioca. Starch can be modified in a number of ways. The viscosity of the starch can be reduced by use of enzymes, thermal treatment, ammonium persulfate, hypochlorite, or acid. In addition, the starch can be chemically modified, for example via hydroxyethylation, carboxymethylation, acetylation, or phosphatizing. Thermoplastic starch may be produced, for example, as disclosed in U.S. Pat. No. 5,362,777, which discloses the mixing and heating of native or modified starch with high boiling plasticizers, such as glycerin or sorbitol, in such a way that the starch has little or no crystallinity, a low glass transition temperature and a low water content. Preferably, the starch does not comprise high viscosity ethoxylated (or “ethylated”) starches.

Once prepared, the ionomer-PVOH composition may be coated onto a substrate as described below.

Substrate Materials

The substrate may be any material providing support, shape, esthetic effect, protection, surface texture, bulk volume, weight, or combinations of two or more thereof to enhance the functionality and handability of the structure. Essentially any substrate material known in the art may be used.

Any support or substrate meeting these desired characteristics may be used with the ionomer-PVOH composition. Cellulosic materials such as paper webs (for example Kraft or rice paper), materials made from synthetic fiber spun fabrics, nonwoven textiles, films, open-cell foams, closed-cell foams, microporous films, or even perforated films having large percentages of open areas such as perforated PE films, may be used as materials for the substrate(s), for example. Metallic foils such as aluminum foil may also be used as substrates.

Cellulosic materials include paper, paperboard, cardboard, and pulp-molded shapes. Paper, paperboard, cardboard and the like refer to physical forms derived from cellulose or its derivatives that have been processed as a pulp and formed by heat and/or pressure into sheets. Paper describes thin sheets made from cellulose pulp that are somewhat flexible or semi-rigid. In general, paperboard and cardboard are thicker, rigid sheets or structures based on paper. Typically, paperboard is defined as paper with a basis weight above 224 g/m². In accordance with the present disclosure, the paper layer or paperboard layer used in the substrate may have a thickness of 30 to 600 μm and a basis weight of 25 to 500 g/m², or 100 to 300 g/m². Cardboard can be a monolithic sheet or can have a more complex structure, such as corrugation. Corrugated cardboard comprises a sheet of corrugated paper adhesively sandwiched between two flat sheets of paper. A coating of the ionomer-PVOH blend may be useful as an adhesive for producing the corrugated cardboard. Pulp-molded shapes are typically nonplanar shapes in which the cellulosic pulp is molded into a rigid shape by application of pressure and/or heat. An example pulp-molded shape is an egg carton.

Example substrates also include a textile or porous sheet material. A textile may also include nonwoven textiles prepared from polypropylene, polyethene, polyesters such as polyethylene terephthalate or mixtures thereof, and other spun bonded polymer fabrics. Sheets made from synthetic fiber spun fabrics, such as nonwoven textiles, may be used as a textile substrate. Cloth that is woven, knitted or the like is also suitable as a textile substrate. Natural fibers alone or in combination with man-made fibers can also be used in textile substrates. A fabric may comprise flame retardant(s), filler(s), or additive(s) disclosed above.

The substrate material may be in the form of a film, sheet, woven fabric, nonwoven fabric and the like. The substrate material may be unoriented or oriented, such monoaxially or biaxially oriented. The substrate material may comprise a polymeric or a metal composition. The substrate may be treated to enhance, for example, adhesion with the coating. The treatment may take any form known in the art such as for example, adhesive, primer or coupling agent treatments or surface treatments, such as chlorine treatments, flame treatments (see, e.g., U.S. Pat. Nos. 2,632,921; 2,648,097; 2,683,894; and 2,704,382), plasma treatments (see e.g., U.S. Pat. No. 4,732,814), electron beam treatments, oxidation treatments, chemical treatments, chromic acid treatments, hot air treatments, ozone treatments, ultraviolet light treatments, sand blast treatments, solvent treatments or corona treatments and combinations of the above. Specific examples of substrate materials include poly(ethylene terephthalate) (PET) films, biaxially-oriented poly(propylene) (BOPP) films, polyamide films, aluminum foil, paper, paperboard, and the like. Preferably, the substrate material is paper, paperboard and the like to allow for repulpability after use.

The substrate material may be any thickness, but generally ranges from about 0.1 to about 20 mils thick, such as from about 0.5 to about 10 mils thick.

Methods to form a coating comprising a blend of ionomer and poly(vinyl alcohol) on a substrate comprise or consist essentially of (1) providing a blend composition comprising or consisting essentially of the PVOH and ionomers described above; (2) providing a substrate described above; and (3) coating the blend composition onto the substrate.

Coating methods include embodiments where the blend combination is in the form of an aqueous dispersion, extrusion coating wherein the blend combination is in molten form and lamination methods wherein the blend combination is in the form of a preformed film.

Dispersion Coating Method

One embodiment of the coating method is wherein the blend composition is in the form of an aqueous ionomer-poly(vinyl alcohol) dispersion comprising or consisting essentially of water and about 1 to about 50 weight % of the combination of (a) and (b) described above. In this embodiment, providing the blend composition may comprise or consist essentially of the dispersion methods described above. This embodiment further comprises (4) drying the coated substrate at a temperature of about 20 to about 150° C.

In some embodiments the polymer composition can be coated directly on a substrate using impregnation and coating techniques. For example, the ionomer-PVOH composition may be a coating applied directly on the substrate (via spraying, painting or other appropriate application methods). Such coating can be applied using spreading methods known in the art such as with a rubber doctor blade.

The composition can be applied to one side or both sides of a substrate. In the case where the substrate is coated or laminated on one side, the composition may be applied to the side that is directly exposed to the environment to provide a liquid-impermeable outer surface. Alternatively, in applications where mechanical wear or abrasion is likely, the composition may be applied to the side of the substrate opposite the side exposed to the mechanical wear to afford protection of the polymeric composition.

In other embodiments the composition can be impregnated in a substrate or the substrate can be impregnated in the polymer.

The ionomer-PVOH composition may be formed at least partially in the substrate by impregnating the substrate with the coating composition as an aqueous dispersion and then drying the composition while it is in contact with the pores of the substrate.

The composition can be dispersed throughout the substrate such as a loosely woven fabric where the composition fills gaps in the substrate and does not just adhere on the surface of a substrate. The substrate can be impregnated inside the ionomer-PVOH composition through coating processes to have the ionomer-PVOH compositions on both sides of the substrate.

The coating as an aqueous dispersion can be applied to the substrate in any suitable manner known in the art, including gravure coating, roll coating, wire wound rod coating, dip coating, flexographic printing, spray coating and the like. Excess aqueous dispersion coating composition can be removed by squeeze rolls, doctor knives and the like, if desired.

For the preferred paper and paperboard substrates, the substrates may be applied to the preformed paper or paperboard substrate, as described above, or during the manufacture of the paper or paperboard substrates using, for example, size presses, such as a puddle size press, a metering size press, a vertical size press, an inclined size press and a horizontal size press, roll coaters, gate-roll coaters, blade coaters, bill blade coaters, and sprayers to coat the coating composition onto the paper or paperboard substrate.

The coating composition can be applied to one or both sides of the substrate.

After coating the substrate, the aqueous dispersion is dried to provide a solid coating of the ionomer-PVOH blend on the substrate. As used herein, “drying” means removal of water from the aqueous dispersion, such as by evaporation, freeze drying, or the like. Drying may include allowing the dispersion to dry under ambient conditions (temperatures of about 20 to about 30° C. and atmospheric pressure). Alternatively, drying may include application of elevated temperatures (such as up to 100° C. in an oven or heating tunnel) and/or reduced pressure. Freeze drying involves rapid freezing and drying in a high vacuum.

Non-Dispersion Coating Methods

Another embodiment is wherein the blend composition is in the form of a preformed film. In this embodiment, the invention provides a method to form a coating comprising an ionomer and PVOH on a substrate, the method comprising or consisting essentially of (a) providing a preformed film of an ionomer-PVOH composition as described above;

(b) producing a prelaminate structure comprising the ionomer-PVOH film layer adjacent to a substrate layer;

(c) laminating the ionomer film layer to the substrate layer at a temperature from about 50 to about 150° C. and optionally with applied pressure;

(d) cooling the coated substrate to a temperature of about 20 to about 30° C.

The preformed film of the ionomer-PVOH composition may be produced by any known art method. For example, thin films can be formed by dipcoating; by providing a thin layer of an aqueous ionomer-PVOH dispersion followed by drying; or any other processes known to those skilled in the art.

In the film lamination method, the ionomer-PVOH coating layer can be included in a multilayer structure with one or more layers of additional material(s) to provide a multilayer coating. In such processes, the ionomer-PVOH coating layer may be applied so it is in direct contact with the substrate, or it may be applied so it is in contact with a layer intervening between the substrate and the ionomer-PVOH layer.

The actual making of the multilayer film and corresponding film structures can generally be by any such method as practiced in the art. As such, film and film structures used as a substrate for the ionomer-PVOH composition can be typically cast, extruded, co-extruded and the like including orientation (either axially or biaxially) by various methodologies (e.g., blown film, bubble techniques, mechanical stretching or the like, or lamination). It should be appreciated that various additives as generally practiced in the art can be present in the respective film layers including the presence of tie layers and the like, provided their presence does not substantially alter the properties of the film or film structure. Thus, it is contemplated that various additives such as antioxidants and thermal stabilizers, ultraviolet (UV) light stabilizers, pigments and dyes, fillers, anti-slip agents, plasticizers, other processing aids, and the like may be advantageously employed.

The preformed film of the ionomer-PVOH composition can be applied to one or both sides of the substrate. Preferably, the ionomer-PVOH composition layer has a thickness of about 0.1 mil to about 20 mils, more preferably a thickness of about 0.3 mil to about 10 mils and most preferably a thickness of about 0.5 mil to about 5 mils.

The laminate structures may be produced by any known art method. For example, the prelaminate structure can be produced by plying the preformed film of the ionomer-PVOH composition with the substrate followed by passing through heated nip rolls or through an oven to form the laminate.

In these non-dispersion coating methods, after coating the substrate, the coated substrate is cooled to provide a solid ionomer-PVOH coating on the substrate. As used herein, “cooling” includes allowing the ionomer-PVOH coating to cool under ambient conditions (temperatures of about 20 to about 30° C. and atmospheric pressure) and/or by application of reduced temperatures such as by use of chill rolls or the like.

Additional layers may be applied to the coated substrate following coating. For example, additional aqueous or solvent-based dispersions not comprising an ionomer-PVOH combination may be applied to the coated substrate. Alternatively, multilayer structures may comprise additional thermoplastic materials applied over the ionomer-PVOH layer by extrusion coating, lamination or the like. In such cases, the ionomer-PVOH coating becomes an inner layer in a multilayer structure.

The ionomer-PVOH coating composition can also be accommodated between two layers of substrate in a sandwich-like manner Several layer assemblies can also be assembled one above the other. For example, the configuration can comprise the ionomer-PVOH layer, a substrate layer, another ionomer-PVOH layer, another substrate layer, and so on, depending upon desired applications of the structure. Other configurations can comprise variations of the aforementioned sandwich configuration, including a plurality of ionomer-PVOH layers, a plurality of substrate layers, and so forth, including mixtures thereof.

In such cases, in aqueous dispersion coating methods the ionomer coating may be maintained in an aqueous state during assembly of the layered structure, followed by drying. In the resulting layered structures, the ionomer-PVOH coating may function as an adhesive layer to bond substrate layers together.

The coated substrates described herein may be used as film or sheet goods for various end uses. Alternatively, the initially prepared coated substrate may be further treated to provide more finished articles.

For example, the coated substrate may be part of a package comprising the coated substrate. The packages may comprise films or sheets of the coated substrate wrapped around the packaged product and optionally comprising other packaging materials. Packages may also be formed of one or more portions of the coated substrate bonded together, for example by heat sealing. The ionomer-PVOH coating is readily heat sealable, allowing for production of packages comprising a coated paper substrate that does not need additional adhesive for sealing. Such packages or containers may be in the form of pouches, bags, boxes, cartons, cups, packets, and the like.

A film or sheet comprising the coated substrate could be further processed by thermoforming into a shaped article. For example, a film or sheet comprising the coated substrate as described herein could be formed into a shaped piece that could be included in packaging. Thermoformed articles typically have a shape in which a sheet of material forms a concave surface such as a tray, cup, can, bucket, tub, box or bowl. The thermoformed article may also comprise a film or sheet with a cup-like depression formed therein. In some cases, the thermoformed film or sheet is shaped to match the shape of the material to be packaged therein. Flexible films when thermoformed as described retain some flexibility in the resulting shaped article. Thicker thermoformed sheets may provide semi-rigid or rigid articles. Thermoformed articles may be combined with additional elements, such as a generally planar film that serves as a lid sealed to the thermoformed article.

Preferably, the container is suitable for containing, transporting or storing food that may contain grease or oil, including snack foods such as chips, crackers, cookies, cereal or nuts; dry noodles, soup mix, coffee, French fries, sandwiches, pet foods and the like. Frozen or chilled foods such as ice cream, vegetables, waffles and the like may also be packaged in packages comprising the coated substrate. Non-food items such as detergents and soaps may also be packaged in packages comprising the coated substrate. Products for serving foods may also be prepared from the coated substrate such as cold drink cups, plates, bowls and the like.

Pouches are formed from coated web stock by cutting and heat sealing separate pieces of coated web stock and/or by a combination of folding and heat sealing with cutting. Coated substrates may be formed into pouches by overlaying and heat sealing the edges of the substrate to form a seal and then sealing across the lengthwise direction of the tube (transverse seal). Other packages include containers, optionally further comprising lidding films such as cups or tubs prepared from coated substrates as described herein and flexible packages made by laminating the coated substrate to another webstock to improve characteristics such as stiffness and appearance.

Preferred packages comprise one or more of the preferred or notable or structures as described herein. Preferred packaged products comprise one or more of the preferred or notable compositions, films, structures or packages as described herein.

Once used for its intended purpose such as for packaging or serving food, the coated substrate is easily recyclable by treatment with hot water. The ionomer-PVOH coating is readily dispersable in hot water, allowing it to be removed from the substrate to allow for recyclability. The recycling may be thought of as recovering usable fiber from the substrate, such as paper. The recovered materials can be reused to prepare other articles, including new containers.

The recycling process may include contacting the container with water at a temperature as low as ambient to 80° C. In some embodiments, the temperature is in the range from 80 to 90° C., or 80 to 85° C., or 85 to 90° C. However, one can appreciate that if the water-dispersable ionomer-PVOH compositions can disperse in such temperatures, they can also be dispersed at temperatures above 90° C. Also, in some embodiments, the container may be cut into pieces before being contacted with water. In normal circumstances, the water-dispersable compositions could be sufficiently dispersed in warm water in 1 hour or less, such as in 30 minutes or less or in 20 minutes or less.

Once the water-dispersable ionomer composition is dispersed in the water, the substrate materials (i.e. recyclable fiber) can be recovered by standard methods. For example, the non-water dispersable materials comprised in the container, such as paperboard base material or aluminum foil, could be separated from the aqueous phase by, for example filtration, for recycling. For the preferred paper substrate, the paper is recyclable by normal means used in the paper industry within limits on coat weight and ionomer content and the weight of the paper. In some cases, it may not be necessary to separate completely the dispersed ionomer-PVOH composition from paper pulp. The fiber can be reused because recycled paper typically contains some small fraction of dispersed “plastic”, waxes, hot melt components, etc., and minimal amounts can be tolerated if the particle size is small.

Removing the coating from the substrate materials may involve one of the following embodiments:

The container (preferably after use) disclosed herein is first mixed with water under low shear conditions at room temperature (about 20 to about 25° C.) and then the temperature or the mixture is raised to about 80 to about 90° C.

The container (preferably after use) disclosed herein is mixed with water under low shear conditions at room temperature and then the temperature of the mixture is raised to about 85 to about 90° C.

The container (preferably after use) disclosed herein is mixed with water that is preheated to a temperature of about 80 to about 90° C. under low shear conditions.

The container (preferably after use) disclosed herein is mixed with water that is preheated to a temperature of about 85 to about 90° C. under low shear conditions.

Following treatment with hot water to remove the coating, the substrate materials can be collected and recycled into new articles. For example, paper and paperboard materials can be repulped by methods known in the art and processed into new articles.

The aqueous ionomer-PVOH dispersion can also be further processed to recover the ionomer-PVOH composition. For example, excess water can be removed by distillation, evaporation, freeze drying, or the like to provide the composition in solid form. Alternatively, the ionomer can be purified from other water-soluble materials by subjecting the aqueous dispersion to acid treatment, providing the base ethylene acid copolymer that is insoluble in water. The solid acid copolymer can be re-neutralized according to methods disclosed herein to provide the ionomer.

### EXAMPLES

Table 1 summarizes the ethylene methacrylic acid dipolymers with copolymerized units of methacrylic acid at the indicated weight % of the total acid copolymer used to prepare the ionomers in Table 2. Ionomers were prepared from the acid copolymers using standard conditions. Melt flow rate (MFR) was measured according to ASTM D1238 at 190° C. using a 2160 g load.

TABLE 1

| | Methacrylic acid (weight %) | MFR (g/10 min) |
|---|---|---|
| ACR-1 | 19 | 400 |
| ACR-2 | 15 | 200 |
| ACR-3 | 19 | 180 |
| ACR-4 | 19 | 60 |
| ACR-5 | 21.7 | 30 |
| ACR-6 | 19 | 250 |
| ACR-7 | 23 | 270 |

### Ionomers

Table 2 summarizes the ionomers derived from the ethylene methacrylic acid dipolymers, with the indicated percentage of the carboxylic acid groups neutralized with sodium hydroxide to form sodium salts or potassium carbonate to form potassium salts. The water dispersibility was determined according to the following procedure, which illustrates addition of the non-neutralized acid copolymer or ionomer to heated water. The procedure produced a mixture of water and 10 weight % solid loading (as weighed prior to addition to the water). Into a 1 quart (946.4 ml) metal can placed into a heating mantle element was added 500 ml of distilled water. An overhead paddle stirrer (3-paddle propeller type stirrer) was positioned into the center of the metal can and turned on to provide slow mixing. A thermocouple was positioned below the water surface between the paddle stirrer and the metal can surface. The paddle stirrer was typically set at a speed of about 170 rpm at the beginning of the process and generally raised to about 300 to 470 rpm as the viscosity built during dispersion formation. The distilled water was then heated with an Omega temperature controller to a temperature of 90° C. The non-neutralized acid copolymer resin ACR-1 or ionomer (55.5 grams, in the form of melt cut pellets) indicated in Table 1 was then added in one portion and the resulting mixture was stirred for a total of 20 minutes. The resulting mixture was then allowed to cool to room temperature.

Materials that did not form dispersions are denoted as “No” in Table 2 below. For those materials that formed a dispersion (denoted as “Yes” in Table 3), the dispersion was generally formed in less than 10 minutes and was stable even after being cooled to room temperature. As used herein, “stable” means that the dispersion, a liquid with no visible solids, did not exhibit any visual change after the initial cooling or on storage at room temperature. The Example dispersions remained as liquids with no settling after storing at room temperature for periods of several weeks or longer.

TABLE 2

| | | | | | Water |
|---|---|---|---|---|---|
| | Base | Neutralization | | MFR | Dispersibility |
| Sample | Copolymer | Ion | Level (%) | (g/10 min.) | at 90° C. |
| ACR-1 | ACR-1 | — | 0 | — | No |
| ION-1 | ACR-2 | Na | 51 | 4 | No |
| ION-2 | ACR-2 | Na | 70 | 0.9 | No |
| ION-3 | ACR-1 | Na | 40 | 12.7 | No |
| ION-4 | ACR-3 | Na | 45 | 3.7 | No |
| ION-5 | ACR-4 | Na | 50 | 0.8 | No |
| ION-6 | ACR-5 | Na | 40 | 0.7 | No |
| ION-7 | ACR-1 | Na | 50 | 5.3 | Yes |
| ION-8 | ACR-1 | Na | 60 | 1.4 | Yes |
| ION-9 | ACR-1 | Na | 70 | 1 | Yes |
| ION-10 | ACR-7 | Na | 55 | 1.4 | Yes |
| ION-11 | ACR-2 | K | 65 | 2.3 | No |
| ION-12 | ACR-4 | K | 50 | 0.9 | No |
| ION-13 | ACR-6 | K | 50 | 3.9 | Yes |
| ION-14 | ACR-1 | K | 50 | 5.4 | Yes |

The data in Table 2 show that ionomers prepared from an acid copolymer with 15 weight % of methacrylic acid did not form aqueous dispersions using this procedure, even with high neutralization levels (Ionomers ION-1, ION-2 and ION-11). Ionomers with neutralization levels less than 50% did not form dispersions, even with acid comonomers above 19 weight % of the acid copolymer (Ionomers ION-3, ION-4 and ION-6). Ionomers ION-5, ION-7, ION-12 and ION-14 involved acid copolymers with the same weight % of methacrylic acid and neutralized to the same level, but with different melt flows. ION-5 and ION-12, each derived from a parent acid copolymer with MFR of 60 and having MFR less than 1, did not provide dispersions. However, ION-7 and ION-14, each derived from a parent acid copolymer with MFR of 400 and having MFR greater than 1, provided dispersions.

The following examples show the method of mixing preformed aqueous SPHPVOH solutions with a preformed aqueous ionomer dispersion. An 11.6 weight % aqueous dispersion of ION-8 was prepared by suspending the solid material in hot (about 90 to about 95° C.) water and stirring until all solid material disappeared. The ionomer dispersion was a translucent milky liquid.

Aqueous solutions of the sub-partially hydrolyzed poly(vinyl alcohol) (SPHPVOH) materials (about 10 to about 15 weight % loading) in Table 3 were prepared by suspending the solid material in cool water and then heating to about 90 to about 95° C. with stirring until all solid material disappears. The SPHPVOH solutions were clear, transparent liquids.

TABLE 3

| | Hydrolysis | 4 weight % Aqueous | Solids Level |
|---|---|---|---|
| SPHPVOH | Level (%) | Viscosity at 20° C. (cp) | (weight %) |
| SPHPVOH-1 | 72-76 | 5-6 | |
| SPHPVOH-2 | 79-84 | 13-17 | |
| SPHPVOH-3 | 78-82 | 36-42 | 9.7 |
| SPHPVOH-4 | 78-82 | 44-52 | 10 |
| SPHPVOH-5 | 74-76 | 28-33 | |
| SPHPVOH-6 | 76-79 | 5-7 | |

Blends of the aqueous ionomer dispersion with the aqueous SPHPVOH solutions were prepared by mixing them together at room temperature. Specifically, each of the aqueous SPHPVOH solutions was mixed with the aqueous ionomer dispersion in ratios of 80:20; 60:40; 40:60 and 20:80 (weight:weight). For example, an aqueous dispersion of ION-8 at 10-12 weight % in water is blended with solutions of SPHPVOH-3 or SPHPVOH-4, each at 9-12 weight % in water.

The viscosities of the dispersions were measured using a TA Instruments AR 2000 controlled-stress rheometer equipped with narrow-gap (1 mm) concentric cylinder geometry. The concentric cylinder geometry consisted of a temperature controlled jacket, a cup (or stator), and a DIN rotor (or bob). When a test was performed, the sample was placed in the cup and then the rotor was inserted. Since the drag of the fluid on the rotor is proportional to the surface area, the contribution to the measured torque from the shaft of the rotor was small relative to the fat part of the rotor. As a result, the height of the fluid on the shaft is not critical and the cup was filled so that the height of the fluid in the cup was above the thick part of the rotor when the rotor was inserted. A solvent cover was placed over the top of the cup. This helped to minimize the effects of solvent evaporation or moisture absorption on the measured properties.

Instrument bias was checked using a nominal 10 cP (actual viscosity 9.5 cP) and a nominal 10,000 cP (actual viscosity 9860 cP) viscosity standard. The bias was 4% or less for both standards at shear rates from 0.1 to 100 sec⁻¹.

The viscosity of the test samples was measured at 25° C. The concentric cylinder geometry was set at the desired test temperature. Proportional amounts of each material for a total of 20 mL were loaded into the cup using a syringe, the solutions were mixed using a spatula for 10 seconds, the DIN was lowered to a gap of 5920 μm between the bottom of the rotor and the cup, a cover was placed over the geometry, and the test was started. A time sweep was performed at a shear rate of 20 sec⁻¹. The viscosity for each sample was monitored as a function of time by taking data points every 10 seconds up to 1800 seconds. The measurement was performed at least in duplicate with a fresh sample loading each time. The results are summarized in Table 4. The column entry “Viscosity Ratio” denotes the ratio of the viscosity of the ionomer-PVOH blend dispersion to the viscosity of the PVOH dispersion without ionomer, each measured at 1800 seconds. The viscosity of each of the 100% samples stabilized

TABLE 4

| | Composition | Viscosity (cp) after time (seconds) | | | | | | Viscosity |
|---|---|---|---|---|---|---|---|---|
| Example | (weight % in water) | 10 | 120 | 500 | 1000 | 1500 | 1800 | Ratio |
| C1 | ION-8 (10) | | | | | | 2.5 | — |
| C2 | SPHPVOH-3 (9.7) | | | | | | 1270 | — |
| 1 | SPHPVOH-3 (7.8) | 1850 | 1837 | 1871 | 1927 | 1985 | 2025 | 1.59 |
| | ION-8 (2) | | | | | | | |
| 2 | SPHPVOH-3 (5.8) | 1695 | 1872 | 1992 | 2198 | 2468 | 2656 | 2.09 |
| | ION-8 (4) | | | | | | | |
| 3 | SPHPVOH-3 (3.9) | 1896 | 3626 | 4657 | 5499 | 6476 | 7320 | 5.76 |
| | ION-8 (6) | | | | | | | |
| 4 | SPHPVOH-3 (1.9) | 9752 | 15090 | 15575 | 17300 | 19685 | 20620 | 16.24 |
| | ION-8 (8) | | | | | | | |
| C3 | SPHPVOH-4 (10) | | | | | | 698 | — |
| 5 | SPHPVOH-4 (8) | 962 | 961 | 973 | 1010 | 1066 | 1107 | 1.59 |
| | ION-8 (2) | | | | | | | |
| 6 | SPHPVOH-4 (6) | 1719 | 2337 | 2696 | 3215 | 3874 | 4333 | 6.21 |
| | ION-8 (4) | | | | | | | |
| 7 | SPHPVOH-4 (4) | 3020 | 5896 | 7688 | 9028 | 11155 | 17320 | 24.81 |
| | ION-8 (6) | | | | | | | |
| 8 | SPHPVOH-4 (2) | 5972 | 16815 | 18190 | 21135 | 22920 | 23660 | 33.9 |
| | ION-8 (8) | | | | | | | |

The data in Table 4 show that the viscosity of the ionomer dispersion (Comparative Example C1) stabilized at around 2.5 cp over the course of measurement until 1800 seconds when the measurement was stopped. The viscosity of each of the poly(vinyl alcohol) dispersions (Comparative Examples C2 C12, C13, C18 and C19) showed similar behavior, stabilizing at 1270 cp (Comparative Example C2) and 698 cp (Comparative Examples C3).

When SPHPVOH-3 and SPHPVOH-4 were combined with ION-8, the viscosity of Examples 1 to 8 exhibited surprising behavior compared to the solutions of SPHPVOH-3 and SPHPVOH-4 without ionomer. Those dispersions demonstrated a dramatic increase in viscosity with the combination of ionomer and SPHPVOH, with increases in viscosity of greater than 25% (greater than 50%) at a 1:4 ratio of ionomer to SPHPVOH. The viscosity further increased as the proportion of ionomer increased, with increases of about 16 to about 35 times that of the respective SPHPVOH solution without ionomer when the ionomer was present in a 4:1 ratio to the SPHPVOH.

The following examples demonstrate coating paperboard with aqueous dispersions. Aqueous ionomer-SPHPVOH dispersions were prepared by mixing aqueous dispersions of ION-8 with aqueous solutions of SPHPVOH-3 and 4 in ratios of 80:20; 60:40; 40:60 and 20:80 (weight:weight). SPHPVOH-3 was blended with ION-8 to give 9 weight % dispersions, and SPHPVOH-4 was blended with ION-8 to give 8 weight % dispersions. Comparative Examples were prepared similarly using the non-mixed materials.

The substrate was a 0.22-inch caliper paperboard with nominal basis weight of 381 grams/meter², treated on one side with clay for printability, commercially available as CartonMate® Bleached Board from RockTerm Converting Company, Demopolis Ala. An 8-inch by 11-inch sample of the substrate was coated on the side opposite to the clay coating in the following manner: The sample was weighed and then attached to a flat piece of plywood with a spring loaded clip at one end. Approximately 80 ml of each of the ionomer-SPHPVOH dispersions prepared as above was applied to the clipped end and the dispersion spread and smoothed with a wire-wound 0036 Meyer rod in one motion to cover the remaining portion of the paper sample. The excess dispersion was removed in the spreading operation. Because of the difficulty in drying to constant weight, the dry coating weight pickup was estimated by immediately reweighing the sample to determine the wet coating weight and calculating the amount of polymer present from the weight % of the dispersion. Depending on the diameter of the wire wound around the rod, the coating weight may be about 4 to about 12 grams per square meter. In these examples, the coating weight was about 6 to about 12 grams per square meter.

The wet coated sample was dried in a forced air oven set at 100° C. for five minutes. After drying the sample was allowed to cool at room temperature and then further conditioned as required for additional testing. The ionomer-SPHPVOH coatings appeared colorless, uniform and slightly glossier than an uncoated control. The coating examples are summarized in Table 5.

TABLE 5

| | | | | | Dry Pickup | |
|---|---|---|---|---|---|---|
| | | Dry | Wet | Wet | Dry | |
| Example | Composition | Weight | Weight | Gain, g | Gain, g | g/m² |
| C4 | ION-8 10% | 24.29 | 29.69 | 5.4 | 0.54 | 8.47 |
| | dispersion | | | | | |
| | SPHPVOH-3 | | | | | |
| | (as % of solids) | | | | | |
| 9 | 20 | 24.97 | 29.02 | 4.05 | 0.3645 | 6.08 |
| 10 | 20 | 24.98 | 29.62 | 4.64 | 0.4176 | 6.96 |
| 11 | 40 | 25.1 | 29.83 | 4.73 | 0.4257 | 7.10 |
| 12 | 40 | 25.04 | 30.04 | 5 | 0.45 | 7.50 |
| 13 | 60 | 24.96 | 29.22 | 4.26 | 0.3834 | 6.39 |
| 14 | 60 | 24.95 | 29.75 | 4.8 | 0.432 | 7.20 |
| 15 | 80 | 24.9 | 29.28 | 4.38 | 0.3942 | 6.57 |
| 16 | 80 | 24.93 | 29.98 | 5.05 | 0.4545 | 7.58 |
| C5 | 100 | 24.94 | 29.32 | 4.38 | 0.3942 | 6.57 |
| C6 | 100 | 24.99 | 29.88 | 4.89 | 0.4401 | 7.34 |
| | SPHPVOH-4 | | | | | |
| | (as % of solids) | | | | | |
| 17 | 20 | 24.97 | 29.89 | 4.92 | 0.3936 | 6.56 |
| 18 | 20 | 24.97 | 29.89 | 4.92 | 0.3936 | 6.56 |
| 19 | 40 | 24.8 | 30.11 | 5.31 | 0.4248 | 7.08 |
| 20 | 40 | 24.78 | 30.4 | 5.62 | 0.4496 | 7.49 |
| 21 | 60 | 24.82 | 30.29 | 5.47 | 0.4376 | 7.29 |
| 22 | 60 | 24.98 | 29.63 | 4.65 | 0.372 | 6.20 |
| 23 | 80 | 25 | 29.87 | 4.87 | 0.3896 | 6.49 |
| 24 | 80 | 24.95 | 30.04 | 5.09 | 0.4072 | 6.79 |
| C7 | 100 | 24.96 | 29.46 | 4.5 | 0.36 | 6.00 |
| C8 | 100 | 24.92 | 29.77 | 4.85 | 0.388 | 6.47 |

The Moisture Vapor Transmission Rate (MVTR) is a measure of the permeability of a material to water vapor. MVTR of the uncoated and coated substrates may be measured on a Mocon Permatran-W® 101K instrument according to ASTM D6701-01 at 37.8° C. Coated substrates may be tested with the coated side toward the higher moisture. Both the clay-treated side and the untreated side of the uncoated substrate may be tested facing the higher moisture. Transmission rate units are grams per square meter per day.

The coated samples were tested in the Kit test (TAPPI T 559) for grease resistance. The Kit test uses a series of mixed solvents, combinations of castor oil, n-heptane and toluene, numbered from 1 (100% castor oil) to 12 (45/55 ratio of toluene/n-heptane), in order of decreasing viscosity and surface tension. The reported number is the highest number solvent that showed no sign of staining the tested material after 15 seconds of contact.

The coated samples were also tested in the Cobb test (TAPPI T 441) for water resistance. This test measures the weight gain due to water absorption under standard conditions. The Cobb test time can be varied according to the paper type. The test used herein was conducted by pouring 100 ml of water onto a paper sample clamped under a ring enclosing 100 square centimeters and pouring off the water after two minutes exposure. The weight gain is multiplied by 100 to report the results in grams/square meter.

The results of Cobb and Kit tests are summarized in Table 6.

TABLE 6

| | 2 minute Cobb Test, water absorption | | | | Kit |
|---|---|---|---|---|---|
| Example | Dry | Wet | Gain | (g/m²) | Test |
| 9 | 6.800 | 7.073 | 0.273 | 27.3 | |
| 10 | | | | | 5 |
| 11 | 6.800 | 7.168 | 0.368 | 36.8 | |
| 12 | 6.784 | 7.174 | 0.390 | 39 | 7 |
| 13 | 6.779 | 7.359 | 0.580 | 58 | |
| 14 | 6.791 | 7.325 | 0.534 | 53.4 | 12 |
| 15 | 6.778 | 7.21 | 0.432 | 43.2 | |
| 16 | 6.759 | 7.258 | 0.499 | 49.9 | 12 |
| C5 | 6.573 | 6.978 | 0.405 | 40.5 | |
| C6 | 6.605 | 6.998 | 0.393 | 39.3 | 12 |
| 17 | 6.676 | 6.958 | 0.282 | 28.2 | |
| 18 | 6.749 | 7.053 | 0.304 | 30.4 | 6 |
| 19 | 6.761 | 7.145 | 0.384 | 38.4 | |
| 20 | 6.748 | 7.132 | 0.384 | 38.4 | 8 |
| 21 | 6.720 | 7.31 | 0.590 | 59 | |
| 22 | 6.743 | 7.299 | 0.556 | 55.6 | 11 |
| 23 | 6.781 | 7.257 | 0.476 | 47.6 | |
| 24 | 6.800 | 7.295 | 0.495 | 49.5 | 12 |
| C7 | 6.734 | 7.198 | 0.464 | 46.4 | |
| C8 | 6.795 | 7.242 | 0.447 | 44.7 | 12 |
| Uncoated | 6.527 | 6.915 | 0.388 | 38.8 | 0 |

The uncoated substrate had very poor results in the Kit test for grease resistance and relatively high water absorption in the Cobb test. The Examples, coated with aqueous dispersions of ionomer and SPHPVOH provided adequate to excellent grease resistance, as indicated by the high scores in the Kit test. Water absorption resistance as demonstrated by the Cobb test showed improvement as the amount of ionomer increased. In general, good grease resistance could be obtained with SPHPVOH:ionomer ratios from about 10:90 to about 40:60, while providing the best water absorption resistance.

The results summarized in Table 6 show that aqueous blends of ionomers and SPHPVOH can be used as coatings to provide good to excellent grease resistance and improved water resistance for paper and paperboard substrates. Addition of relatively small amounts of SPHPVOH to ionomer dispersions can dramatically improve grease resistance. Additional benefits of using ionomer/SPHPVOH may include improved heat sealing and less water sensitivity over substrates coated with SPHPVOH alone.

Reduced moisture transmission may be found for the coated substrates compared to the untreated substrate.

What is claimed is:

1. A blend composition comprising
(a) about 99 to about 1 weight %, based on the combination of (a) and (b), of a poly(vinyl alcohol) composition comprising a poly(vinyl alcohol) with a hydrolysis level from about 72 to about 84 mole %; and
(b) about 1 to about 99 weight %, based on the combination of (a) and (b), of an ionomer composition comprising a parent acid copolymer that comprises copolymerized units of ethylene and about 18 to about 30 weight % of copolymerized units of acrylic acid or methacrylic acid, based on the total weight of the parent acid copolymer, the acid copolymer having a melt flow rate (MFR) from about 200 to about 1000 g/10 min., measured according to ASTM D1238 at 190° C. with a 2160 g load, wherein about 50% to about 70% of the carboxylic acid groups of the copolymer, based on the total carboxylic acid content of the parent acid copolymer as calculated for the non-neutralized parent acid copolymer, are neutralized to carboxylic acid salts comprising potassium cations, sodium cations or combinations thereof.

2. The blend composition of claim 1 comprising an ionomer wherein the cations of the carboxylate salts consist essentially of sodium cations.

3. The blend composition of claim 1 comprising an ionomer wherein the cations of the carboxylate salts consist essentially of potassium cations.

4. The blend composition of claim 1 wherein (b) is present in the combination of (a) and (b) in an amount from about 10 to about 95 weight %, (a) being present in a complementary amount.

5. The blend composition of claim 1 wherein (b) is present in the combination of (a) and (b) in an amount from about 60 to about 95 weight %, (a) being present in a complementary amount.

6. The blend composition of claim 1 wherein the hydrolysis level of the poly(vinyl alcohol) is from about 72 to about 79 mole %.

7. The blend composition of claim 1 wherein the poly(vinyl alcohol) is characterized by a 4 weight % aqueous viscosity at 20° C. of about 20 to about 75 cp.

8. The blend composition of claim 1 wherein the acid copolymer has a MFR from about 250 to about 400 g/10 min.

9. The blend composition of claim 1 wherein the acid copolymer is an ethylene methacrylic acid dipolymer having about 18 to about 25 weight % of copolymerized units of methacrylic acid.

10. The blend composition of claim 1 wherein the ionomer composition comprises at least 11 weight % methacrylic acid salt and has a MFR of at least 1 g/10 min.

11. The blend composition of claim 1 wherein about 55% to about 60% of the total carboxylic acid groups of the copolymer are neutralized to carboxylic acid salts.

12. The blend composition of claim 1 in the form of an aqueous dispersion comprising water and about 1 to about 50 weight % of the combination of (a) and (b).

13. A method to produce the aqueous dispersion of claim 12 comprising
(1) providing an aqueous poly(vinyl alcohol) solution comprising water and a poly(vinyl alcohol) composition comprising a poly(vinyl alcohol) with a hydrolysis level from about 72 to about 84 mole %;
(2) providing an ionomer composition comprising an ionomer comprising a parent acid copolymer that comprises copolymerized units of ethylene and about 18 to about 30 weight % of copolymerized units of acrylic acid or methacrylic acid, based on the total weight of the parent acid copolymer, the acid copolymer having a melt flow rate (MFR) from about 200 to about 1000 g/10 min., measured according to ASTM D1238 at 190° C. with a 2160 g load, wherein about 50% to about 70% of the carboxylic acid groups of the copolymer, based on the total carboxylic acid content of the parent acid copolymer as calculated for the non-neutralized parent acid copolymer, are neutralized to carboxylic acid salts comprising potassium cations, sodium cations or combinations thereof;
(3) mixing the ionomer composition with the aqueous poly(vinyl alcohol) composition solution optionally with heating to provide a heated aqueous blend dispersion; and
(4) optionally cooling the heated aqueous blend dispersion to a temperature of about 20 to 30° C., wherein the combination remains dispersed in the liquid phase.

14. The method of claim 13 wherein the aqueous poly(vinyl alcohol) solution comprises from about 1 to about 50 weight % of the poly(vinyl alcohol), based on the total weight of the poly(vinyl alcohol) and water.

15. The method of claim 13 wherein the ionomer composition is an aqueous dispersion comprising the ionomer and water.

16. The method of claim 15 wherein the aqueous dispersion is produced by contacting a solid ionomer composition with water at a temperature from about 80 to about 100° C.; optionally followed by cooling to a temperature of about 20 to about 30° C., wherein the ionomer remains dispersed in the aqueous phase; and
wherein the aqueous dispersion comprises from about 1 to about 50 weight % of the ionomer, based on the total weight of the ionomer and water.

17. The method of claim 13 wherein the ionomer composition is in solid form and the mixing comprises
(a) heating the aqueous poly(vinyl alcohol) solution to a temperature from about 80 to about 100° C.;
(b) contacting the solid ionomer composition with the heated aqueous poly(vinyl alcohol) solution;
(c) continuing heating at a temperature from about 80 to about 100° C. until the solid ionomer composition has completely dispersed; or the mixing comprises
(d) contacting the solid ionomer composition with the aqueous poly(vinyl alcohol) solution to provide a mixture;
(e) heating the mixture to a temperature from about 80 to about 100° C. until the solid ionomer composition has completely dispersed.

18. An article comprising the blend composition of claim 1.

19. The article of claim 18 comprising a multilayer structure comprising a coated substrate comprising a surface layer on the substrate and the surface layer comprises the blend composition and the substrate comprises paper, paperboard, cardboard, pulp-molded shape, textile, material made from a synthetic fiber spun fabric, film, open-cell foam, closed-cell foam, or metallic foil.

20. The article of claim 19 wherein the substrate comprises paper, paperboard, cardboard, or pulp-molded shape.

21. A method to form a coating comprising a blend of ionomer and poly(vinyl alcohol) on a substrate, the method comprising
(1) providing a blend composition of claim 1;
(2) providing a substrate; and
(3) coating the blend composition onto the substrate.

22. The method of claim 21 wherein the substrate is paper, paperboard, cardboard, pulp-molded shape, textile, material made from a synthetic fiber spun fabric, nonwoven fabric, film, open-cell foam, closed-cell foam, or metallic foil.

23. The method of claim 21 wherein the blend composition is provided in the form of an aqueous dispersion comprising water and about 1 to about 50 weight % of the combination of (a) and (b); the blend composition is coated onto the substrate as the aqueous dispersion and the method further comprises (4) drying the coated substrate at a temperature of about 20 to about 150° C.

24. The method of claim 21 wherein the blend composition is provided in the form of a preformed ionomer-PHPVOH film comprising the combination of (a) and (b); (3) comprises (3a) producing a prelaminate structure comprising the ionomer-PHPVOH film layer adjacent to the substrate; and (3b) laminating the ionomer-PHPVOH film layer to the substrate at a temperature from about 50 to about 150° C., optionally with applied pressure; and the method further comprises (4) cooling the coated substrate to a temperature of about 20 to about 30° C.
